(19) United States
(12) Patent Application Publication
(10) Pub. No.: US 2016/0371273 A1
(43) Pub. Date: Dec. 22, 2016

(54) SYSTEM AND METHOD FOR SEARCHING FOR SPECIFIC TYPES OF ITEMS BASED ON PEER RANKING OF QUALITY

(71) Applicant: WYMP, Inc., Fremont, CA (US)

(72) Inventors: Valentine Lan, Fremont, CA (US); Johnny Dara Neang, Union City, CA (US); Brett S. Millar, San Mateo, CA (US)

(73) Assignee: WYMP, INC., Fremont, CA (US)

(21) Appl. No.: 14/743,314

(22) Filed: Jun. 18, 2015

(51) Int. Cl. G06F 17/30

(52) U.S. Cl. CPC G06F 17/3053; G06F 17/30528

(57) ABSTRACT

A system and method that enables users to expeditiously search for specific items features: 1) the geographic location of the user or the geographic area in which the user is searching; 2) the specific type of item desired; and 3) the ranking of the quality of the item based upon other user's ranking. The method is based on a three step process involving: 1) the user typing the desired item to be searched from a web based or mobile device which detects the user's location or geographic area being searched; 2) a list of similar items being populated for that geographic area in sequential order based on user preferences and the popularity of other users and paid advertisement by entities and individuals; and 3) upon clicking on the selected item the user can then obtain directions or obtain the contact information of the entities selling the selected item.

### FIELD OF THE INVENTION

The invention relates generally to system and method for web based and mobile communications devices to expeditiously search for specific types of items based on peer ranking of quality. Specifically, an improved system and method for providing rapid and reliable searches for specific types of items based upon user ranking through Internet connected personal computers and wireless (mobile) communication devices is disclosed.

### BACKGROUND OF THE INVENTION

Current Internet protocol search engines and ranking services applications are limited in their ability to find a specific type of item based on the user's search terms and preferences. Specifically, several web based and mobile applications search engines currently exist that allow users to type in a specific search term (phrase, word) and compile lists based on the most common use of the typed phase or word. The general purpose of these lists is to provide users with choices where to buy, how to use, or the background of the searched item. Similarly there are existing web based and mobile application ranking services where a user can search for a specific product or service that ranks the entities selling the product or service based on various parameters relating to the overall experience of other users such as: 1) service; 2) pricing; 3) ambiance; and 4) popularity of the product or service being searched.

None of the current search engines or ranking services are focused solely on the ranking in popularity and quality of a specific item being searched based upon the opinions of other users. For example, if a user were looking for a specific food dish to eat and used any of the current search engines in the market place, the search would result in a list which would likely include recipes about how to make that food item, the origin of that food, and articles and links to a magazine or reviewers opinions on the best place to purchase that food dish in a particular city. Likewise, if a user typed that food dish into one of the existing ranking services, the search would result in a list of Entities selling that food item based on the overall user experience where the popularity and quality of the specific food dish is only one of the factors in the resulting overall Entity ranking.

### SUMMARY OF THE INVENTION

According to one preferred embodiment, a system is accessed either through a web portal or a mobile application downloaded to and accessed through the user's mobile device. After gaining access from one of these two interfaces, the user can search for an item based on the user's current location or geographic area being searched, previous user preferences and the popularity ranking of the item by other users. Once users visit the entity and purchase the desired item, users can then decide whether they like the item and provide input (rank the item) using the mobile application or web portal through an electronic device.

According to another embodiment, in order to search for a specific Item, the user accesses the system through either the system's web portal or the application (app) downloaded to the user's mobile device. The user's location is immediately detected based upon the assisted global positioning system (aGPS) location of the mobile device upon opening the app or the internet protocol (IP) address of personal computer accessing the web portal. The user is then connected to the server and can enter or type in the desired item into the search field and confirm if the search is to be based on the user's current location or another geographic location. After searching, a list is displayed showing pictures from different entities selling the item in descending order based on popularity ranking by other users. The user then selects an item from the list by clicking on the picture of that item and is subsequently provided with the name of the entity selling that item. The user then can select to either get directions or obtain contact related information (address, phone, email, and website) of the selected Entity.

According to yet another embodiment for ranking of the Item, once the user purchased the desired item from the selling entity, the user can then opt to like the item by clicking a like button or a selection under the featured item. If the user did not like the item, the user can abstain from clicking the like selection. The number of users clicking like for that item will determine the overall ranking of that item in that geographic area. The more likes by individual users, the higher the ranking of that specific item when searched by other users. In one embodiment, a single user can only like the specific item once within the same category, and specific entity. In one embodiment, user does not provide negative reviews or commentary inhibiting abuse, fraud and unfair competition. The ranking may be based on the popularity of the item as interpreted by the user community regardless of other aspects of the entity (ambiance, location, pricing, service, etc.).

### BRIEF DESCRIPTION OF THE DRAWINGS

FIG. 1 is a system entity and flow diagram that presents data flow in one embodiment of a system for searching for specific types of items based on peer ranking of quality;

FIG. 2 is a diagrammatic representation of the components of one or more of the portable or stationary user devices according to the embodiment of FIG. 1;

FIG. 3 is a diagrammatic representation of the components of one or more server devices according to the embodiment of FIG. 1;

FIG. 4 is a diagrammatic representation of exemplary database tables used in a database for the embodiment of FIG. 1;

FIG. 5 is a flow diagram illustrating the steps performed by system software of FIGS. 1-4 for searching and accessing information from the system through a web portal interface;

FIG. 6 is a flow diagram illustrating steps performed by system software for accessing the server through a personal computer (PC) according to the embodiment of FIGS. 1-5;

FIG. 7 is an illustrative diagram showing the users' view of the services pages through the steps of searching and selecting the desired item according to the embodiments of FIGS. 1-6;

FIG. 8 is a flow diagram illustrating steps performed by system software for accessing the server through a mobile device app through various operating system platforms according to the embodiment of FIGS. 1-7;

FIG. 9 is a flow diagram illustrating steps performed by system software for searching and accessing information from the system through a mobile device according to the embodiments of FIG. 1-8; and

FIG. 10 is an illustrative diagram showing the users' view of screen shots of pages through the steps of searching and selecting desired item.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide a system and method for web based and mobile communications devices to expeditiously search for specific types of items based on peer ranking of quality.

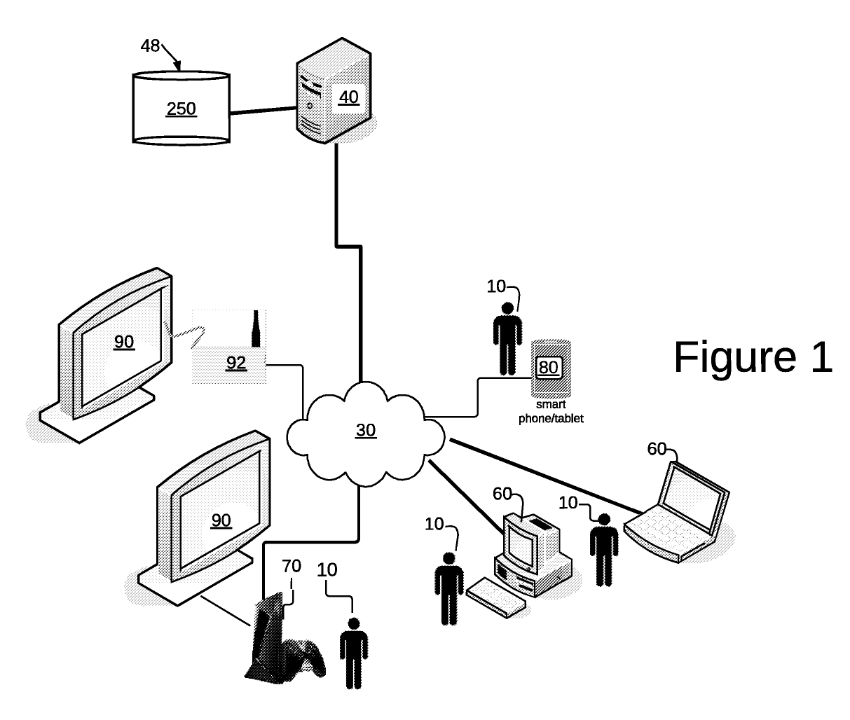

With reference to FIG. 1, a diagrammatic representation of an exemplary internet-based system is shown in which the system and method may operate according to one embodiment. As is typical on today's internet 30, users 10 may connect to and use the internet 30 over several platforms. Those platforms may include personal computers 60, mobile phones or tablets 80, or the like. One of the latest ways to connect to the internet includes using internet protocol television, or IPTV, boxes 92. These IPTV boxes 92 include a wireless or wired device that has a memory and storage for applications or apps that connects to the internet 30. Through an IPTV box 92, users may use the apps contained therein to display videos, pictures, and internet sites on a television (TV) 90. The television is typically connected to the IPTV box 92 via an HDMI cord, component cable, or audio/video (A/V) input lines.

Over and above the mobile phones and tablets 80, computers 60, and the like, discussed above, other popular devices, such as modern game consoles 70, are now capable of video play. Game consoles 70 such as the XBOX®, Playstation®, Nintendo®, Wii®, and others, provide for internet video presentation. Just as with the IPTV box 92, game consoles 70 typically connect to a TV 90 on which videos may be viewed and games played.

One or more servers 40 may include one or more storage devices 48 containing one or more databases 250.

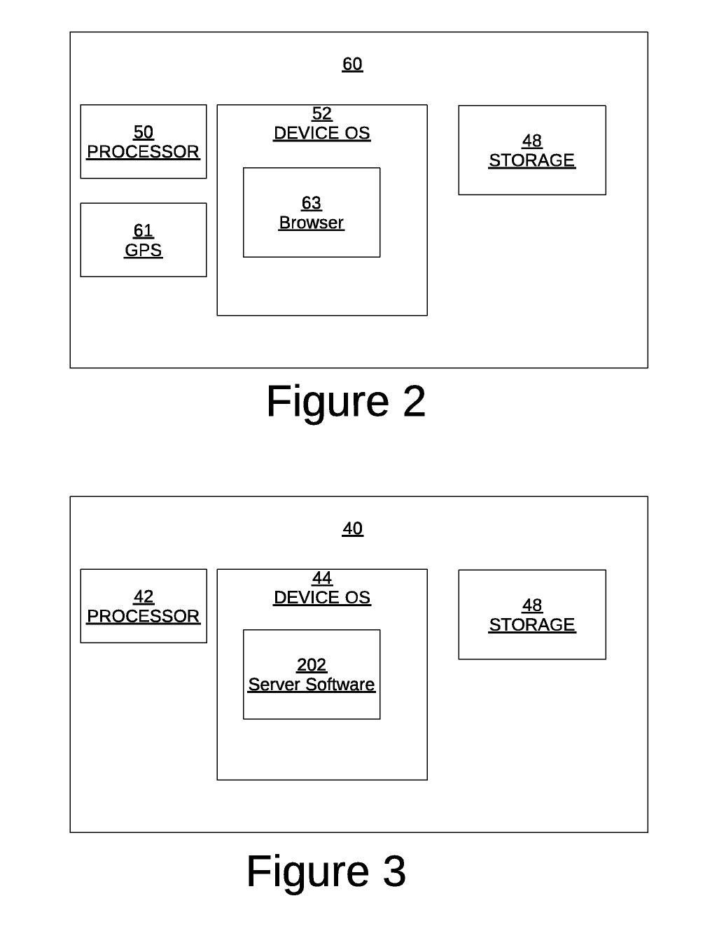

With reference to FIG. 2, a diagrammatic representation of the internal components of one or more of the user devices 80 (92, 70, 60 in FIG. 1) is shown. As those skilled in the art would recognize, each user device 80, 92, 70, 80 may include a processor 50 and operating system 52, on which executable instructions of a browser app 63 may execute. As those skilled in the art would recognize, the browser app 63. Further, the user devices 60, 92, 70, 80 may each have a random access memory (RAM) 58 that may be used for running browser app 63, loading programs, and storing program variable data. Further, mobile devices 80, such as smart phones and tablets, and even mobile computers 60, may include a geographic positioning system (GPS) 61.

With reference to FIG. 3, a diagrammatic representation of the internal components of the server device 40 of FIG. 1 is shown. As those skilled in the art would recognize, the server device 40 may include a processor 42 and server operating system 44, on which executable instructions of server software 202 may execute. As those skilled in the art would recognize, the computer program, which may embody server software 202, may be loaded by an operating system 44 for running on the server 40.

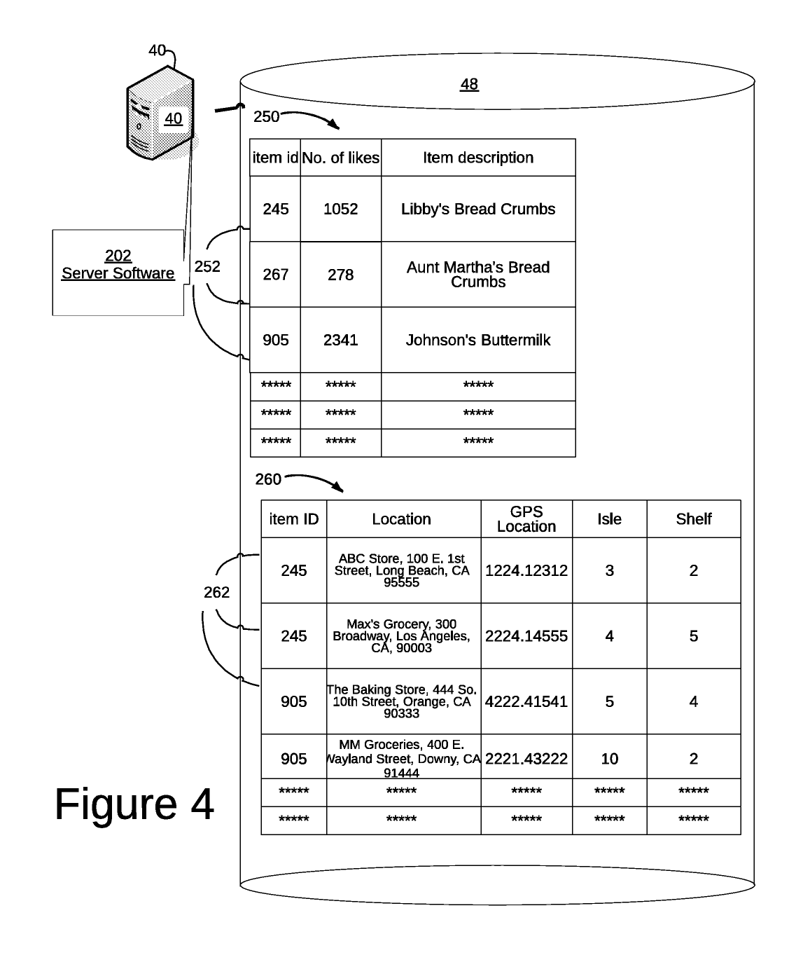

With reference to FIG. 4, a diagrammatic representation of the one or more servers 40, and a storage device 48, is shown. As indicated above, the server 40 may have executing within it server software 202. The server software 202 may comprise instructions to run online search and display software accessed by users 10. The storage device 48 may store one or more databases to store food and ingredient rating data. An exemplary database table 250 is shown in FIG. 4 illustrating some of the electronic data that may be stored and transformed to manage food and ingredient rating data. For example, each record 252 of table 250 may contain the food and ingredient data. Each record 252 may contain a field for food item identifier (ID), a field for number of likes for that food item, and a description field.

Another table 260 may contain food and ingredient location data. For example, records 262 in table 260 may contain the item ID, the location of the store for the item ID, wherein each item ID may have multiple records 262 wherein different stores may have the item, and fields for more granular location data for once the user 10 is in the store, such as isle and shelf location for the item. Further, in one embodiment, a GPS location field may include GPS latitude and longitude data for the store and item.

### Accessing and Using the System from a PC and System Website

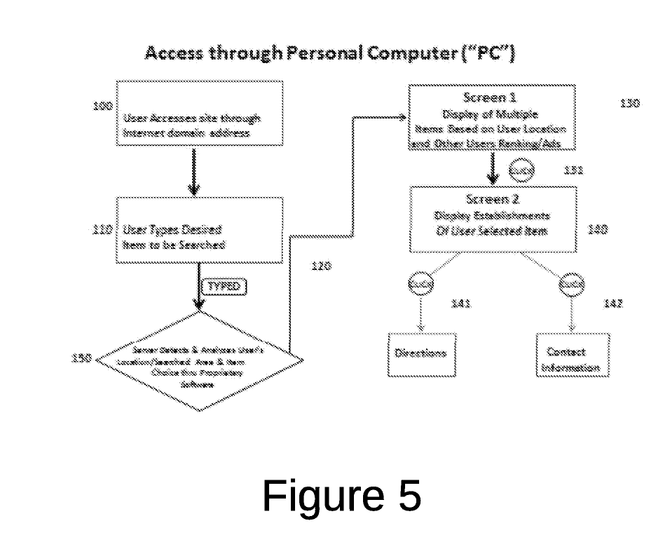

With reference to FIG. 5, a personal computer 60 could be a traditional PC or laptop running off of Linux, Windows or iOS platforms, herein referred to as PC. In step 100, access to the server 40 may be gained through either wireless or hard-wired communication to the internet 30 by typing the web address of the systems website produced by server software 202. Upon singing in as unique user 10 or as a guest user 10, the user 10 may be connected through internet 30 protocols to the system server 40. The server 40 communicates back to the user's PC 60 and determines the user's geographic location based on the internet protocol (“IP”) address in which the PC 60 is connected to the internet 30 through wireless or hardwire modem. Alternatively, the user 10 may type in a separate geographic area, outside of the PC address in which the user wishes to search for an item. The location information is transmitted back to the server 40.

In step 110, therein, the user 10 may type the specific item the user is looking for either in their immediate geographic area or another area in which the user desires to search for a specific item. Once typed in step 110 the name of the item may be transmitted back to system server 30 wherein the system software 202 may search for that item within the database 250 within a default range of 0.3 miles (4.83 kilometers) of the user's geographic location or the area being searched, where the range of the search can be expanded or contracted based on the user's desire to limit or expand the entities to be searched for that item. In step 150, the system software 202 may then analyze that information against the database 250, prioritizes and formats that data information based upon other user's previous ranking by likes, and populates a list in descending value listing the highest ranked item at the top. Therein, the system software 202 transmits the populated list 120 to the user's PC 60 displaying the searched item list with pictures of that item in step 130 (“screen 1”). The user can then scroll through the list of that item and then select by clicking (step 131) on the item from the business the user chooses. The html portion of the system software 202 on the PC may then transmit a page of the entity back to the user displaying the item searched by the user as well as similar top ranked items sold at that entity in step 140. The user can then either click to obtain directions in step 141 to the entity from the user's current location, or click to obtain contact information in step 142 for that entity (telephone, email, and/or address).

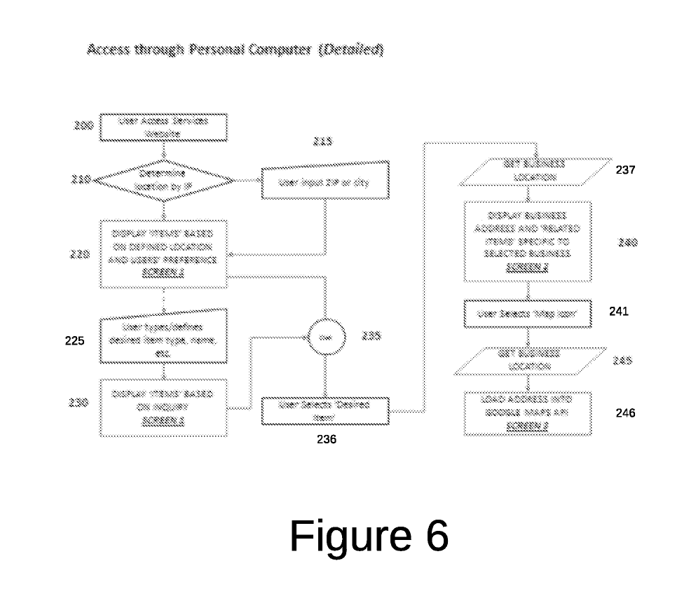

FIG. 6 is a flow diagram illustrating in greater detail the flow of information between the user's PC 60 and the system server 40, including the initial splash page based on the determination of the user's location or the geographic region being searched. In step 200, the user's PC may access the server system 40 web portal through the internet 30. Upon accessing the sever system 40 web portal, in step 210, the system server software 202 may identify the user location through the PC's IP address from where it is being used or (from step 215), the typed in geographic location to be searched (through either a typed in zip code or name of city). In step 220, the server software 202 may then send the user 10 a splash page on the system website that lists suggested popular items in the user's geographic area or the area being searched. In step 225, upon the user typing in an item to be search, in step 230, the server software 202 reads the database 252 to compile a list that is then sent to the user's PC and displays that list of the specific searched items, including a picture of the items, from various entities for the geographic area being searched in descending order based on the ranking by other users. In step 235, after reviewing the list of items, the user 10 may then click on the desired item to select an entity (step 236), after which, in step 237, the system software 202 may direct the user 10 to the entity page with the selected/searched item. Also, in step 240, the system software 202 may cause other popular items, as determined by other users 10, that available at that entity to be concurrently displayed. In step 241, the user can then click to select the contact information of that entity (telephone, email and address). In step 242, the system software 202, the system software 202 may provide the business location, and in step 245, obtain directions and mapping to the entity location through the integrated global positioning system (“GPS”) mapping program (Google Maps or similar program in step 246).

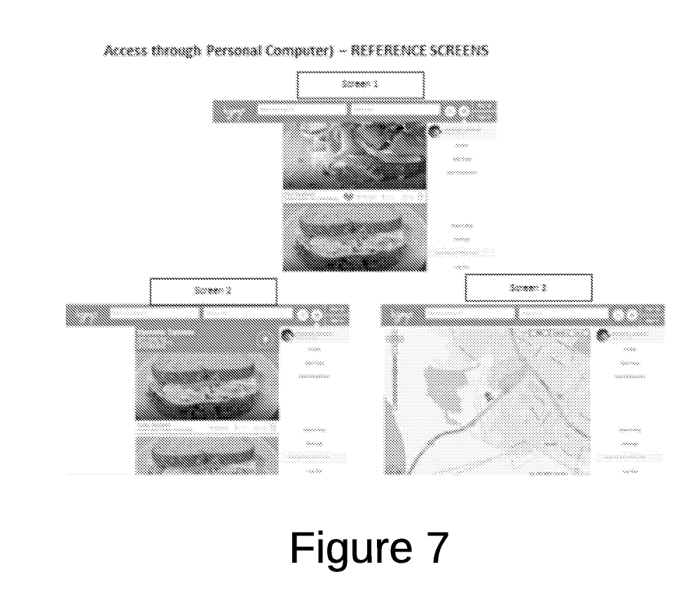

FIG. 7 is an illustrative diagram showing the user's view of the system pages through the steps of searching and selecting the desired item.

### Accessing and Using the System Through a Software Application (“App”) Downloaded to the User's Mobile Device

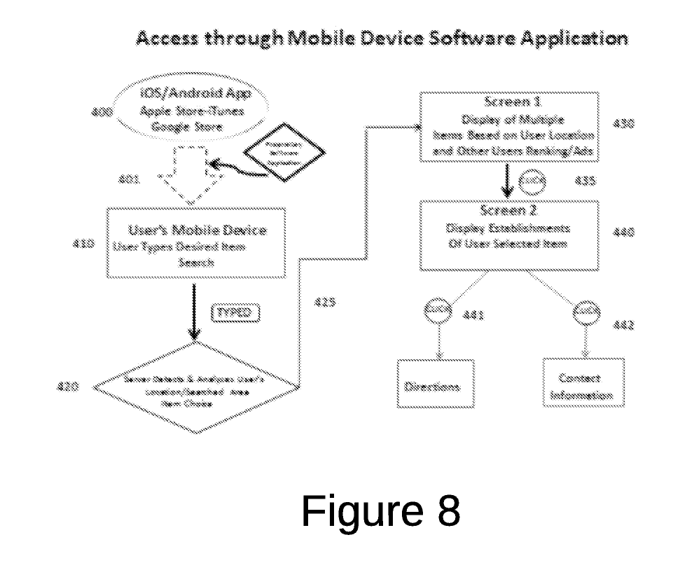

With reference to FIG. 8, a flow diagram illustrates the steps performed by system software 202 to provide access to the server software 202 using mobile device 80. A mobile device 80 can be a tablet, smart phone or similar device capable of searching the worldwide web 30 via cellular or local area wireless internet (“WiFi”) connection. In order for the user 10 to access the system software 202, in embodiments that use more than just html access, in step 400 the user 10 may first download a portion of the system software 202 comprising a mobile application or app from an application store (e.g. Apple Store®, iTunes®, Google Play®, Amazon Appstore®, etc.). In step 401, upon locating the system software App, the user may then download the app portion of the system software 202 through wireless internet connection to their mobile device. Once the App is downloaded, the user 10 may then access the server software, which then detects the user's mobile device location through its aGPS location (cell tower triangulation and global satellite positioning). The aGPS system (61 in FIG. 2) is normally imbedded at the semiconductor (chip) level for most mobile devices 80. The app portion of the system software 202 may integrate with the aGPS location to facilitate accurate searching of items within a specific geographic area. In step 410, the user 10 may type the desired item to be searched through the app portion of the software 202. In step 420, the system software 202 may then search the database 250 for the same item within the user's location within default range of 0.3 miles (4.83 kilometers) of the user's geographic location or the area being searched, where the range of the search can be expanded or contracted based on the user's desire to limit or expand the entities to be searched for that item. In step 420, the system software 202 may then analyze that information against the database 250, prioritize and format found data based upon other user's previous ranking by likes, and populate a list in descending value with the highest ranked item at the top. In step 425, the system software 202 may transmit the populated list to the user's mobile device 80, and in step 430, the app portion of the software 202 may display the searched item list with pictures of that item (page 1). In step 435, the user can then scroll through the list of that item and then select by clicking on the item from the entity the user 10 chooses. In step 440, the system software 202 may then transmit a page of the entity back to the user 10 displaying the item searched by the user as well as similar top ranked items sold at that entity. The user can then either click to obtain directions in step 441 to the entity from the user's current location; or click to obtain contact information in step 442 for that entity (telephone, email, and/or address). Additionally, because the app portion of the system software 202 is on a mobile device, the user 10 can click directly on the telephone number or email address of the entity to communicate directly with the business with an additional click.

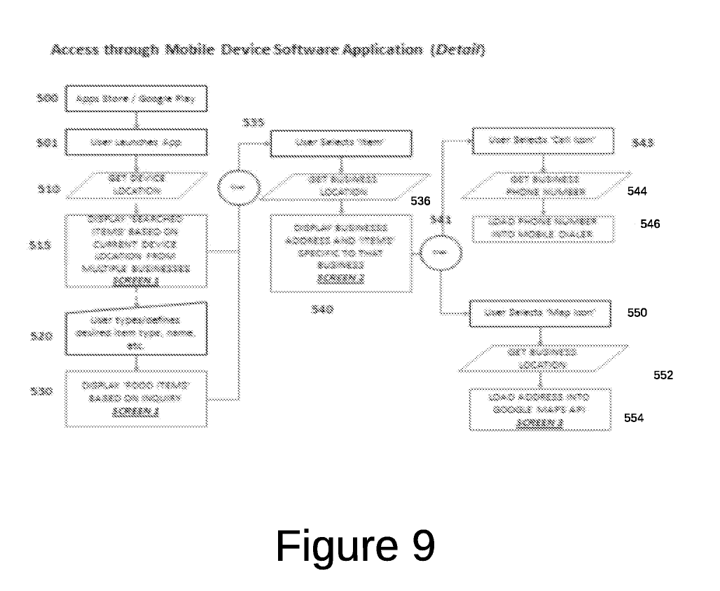

FIG. 9 is a flow diagram illustrating in greater detail the flow, analysis and transfer of information and data between the user's mobile device and the server 40, including the initial splash page based on the determination of the user's location or the geographic region being searched. In step 500, the user 10 accesses the system's app portion of the system software 202 through a software apps store. Therein, the app portion of the system software 202 may then be downloaded to the user's mobile device 80. In step 510, once the user 10 launches the app portion of the system software 202 from their mobile device 80, the user's device location is detected through aGPS by the services server. In step 515, based on the user's device 80 location, a splash page is transmitted by the system software 202 to the mobile device displaying the current items being searched in the user's immediate geographic area. In step 520, the user then types the item desired to be searched, which upon clicking, transmits the search term to the system server 40. In step 525, using a proprietary algorithm the system searches the existing server database for the same item within the user's location or the area being searched and formats that data information based upon other user's previous ranking by likes and populates a list in descending value listing the highest ranked item at the top. In step 530, the system software transmits the populated list to the user's mobile device 80 displaying the searched item list with pictures of that item (Screen 1). In step 535, the user 10 may scroll through the list and selects that item at the desired entity location by clicking. In step 536, the system software 202 may then transmit a page of the entity back to the user for displaying the item searched by the user as well as similar top ranked items sold at that entity in step 540. In step 541, the user can then either click to display the address, step 550, and directions to the entity, step 552, from the user's current location, step 554; or in step 542, click to obtain contact information for that entity, step 544 (telephone, email, and/or address). In step 546, the user can then click to call the entity (to order or place a reservation).

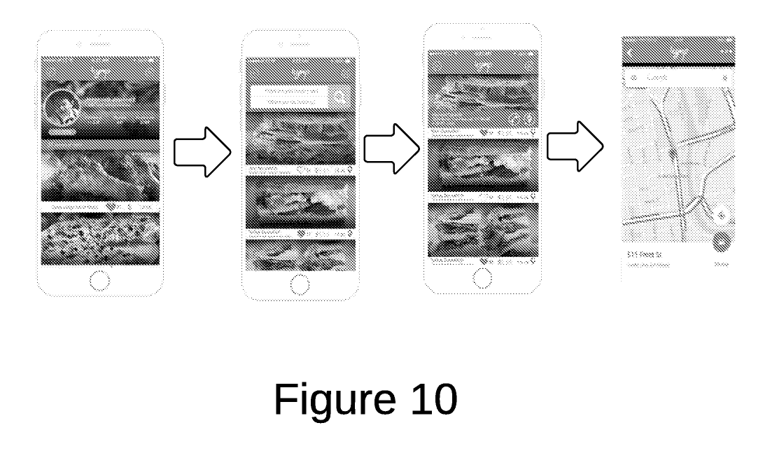

FIG. 10 is an illustrative diagram showing the users' view of the services pages through the steps of searching and selecting desired item.

It should be understood, of course, that the foregoing relates to exemplary embodiments of the invention and that modifications may be made without departing from the spirit and scope of the invention as set forth in the following claims.

1. A server system for searching for specific types of items based on peer ranking, comprising:
a processor;
a network connection;
a database having data related to the items capable of being transformed, the database further capable of storing one or more locations for each item;
a first set of instructions executable on the processor capable of receiving one or more like selections for each item, and transforming the data to store the number of like selections received for the item; and
a second set of instructions executable on the processor capable of receiving a search query request through the network, executing the search query request against the database, and producing a results list of the search query request containing a subset of items based on the query request ordered by the number of likes received for each of the items in the subset of items.

2. The system of claim 1, wherein the items are food items.

3. The system of claim 2, wherein each of the subset of items is selectable through the network to retrieve the one or more locations for the item.

4. The system of claim 3, wherein the one or more locations are each selectable by the user on a network attached device by a user to obtain global position system directions.

5. The system of claim 4, wherein the one or more locations contain store name, address, isle and shelf information.

6. A method for searching for specific types of items based on peer ranking, comprising:
storing data in a database having data related to the items capable of being transformed, the database further capable of storing one or more locations for each item;
receiving one or more like selections for each item through a network, and transforming data to store the number of like selections received for the item;
receiving a search query request through the network;
executing the search query request against the database; and
producing a results list of the search query request containing a subset of items based on the query request ordered by the number of likes received for each of the items in the subset of items.

7. The method of claim 6, wherein the items are food items.

8. The method of claim 7, wherein each of the subset of items is selectable through the network to retrieve the one or more locations for the item.

9. The method of claim 8, wherein the one or more locations are each selectable by the user on a network attached device by a user to obtain global position system directions.

10. The method of claim 9, wherein the one or more locations contain store name, address, isle and shelf information.
